(19) United States
(12) Patent Application Publication
(10) Pub. No.: US 2005/0222710 A1
(43) Pub. Date: Oct. 6, 2005

(54) Mechanical arrangement and components for reducing error in deduced reckoning

(76) Inventors: Steven E. Schell, Arcadia, CA (US); Joseph Michael Brown, Valencia, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/818,756

(22) Filed: Apr. 6, 2004

(51) Int. Cl. G06F 19/00

(52) U.S. Cl. 700/245

(57) ABSTRACT

The present application discloses a mechanical arrangement and components for reducing errors in position estimation in mobile robotic vehicles that use deduced reckoning. The arrangement provides a method for determining the weight to be carried by the driven wheels to provide increased or maximum contact force between the driven wheels and a support surface, which in turn reduces or minimizes wheel slippage and reduces or minimizes vehicle tilting. The arrangement further provides uniquely shaped rolling elements that generate reduced sideways directed forces on the vehicle, thus reducing or minimizing wheel slippage.

### BACKGROUND OF THE INVENTION

1. Field of the Invention

The present invention relates to error reduction in autonomous mobile machines that perform deduced reckoning on various surfaces.

2. Description of the Related Art

Many autonomous mobile machines navigate using deduced reckoning. Deduced reckoning calculates the current or updated position and heading of a vehicle based on measurable factors associated with movement, such as the direction of travel, the speed of travel, and the time spent traveling in specific directions. The method results in estimations of position and heading.

Robotic or self-mobile wheeled vehicles that use deduced reckoning methods have traditionally relied on information about the motion of their wheels. Driven wheels have been the most convenient source of information, since driven wheels typically include associated motion control hardware, such as rotary encoders and servo amplifiers. This motion control hardware tracks certain wheel parameters, such as rotation and current. Current can sometimes be used to measure torque indirectly.

Slippage between the wheels and the surface upon which they rest generates substantial cumulative errors in position estimation. These errors can be especially great on carpeted floors and on loose or vegetated ground. These errors are also typically worsened when information is gathered from the driven wheels, because drive torque exacerbates wheel slippage. The navigational errors caused by wheel slippage have spurred many attempts to improve deduced reckoning accuracy by using information from sources other than the wheels.

Existing mobile robotic vehicles include one or more of a wide variety of navigational systems. For example, one internal position error correction system adds additional measurement systems to robots. In a first variation, a trailer equipped with one or more wheel encoders modifies a robot that navigates using dead reckoning. In a second variation, a pair of robotic vehicles coupled with a compliant linkage monitors relative positioning between the vehicles. In a third variation, a pair of decoupled mobile robotic vehicles, each performing dead reckoning, includes individual transmitter and receiver arrays that determine relative positioning between the vehicles. This system reduces accumulated deduced reckoning error, but is prohibitively expensive for most commercial markets.

Another position determining system is infrastructure independent. This system captures images of the surface upon which the robot rests and compares them to previously stored images. This system disadvantageously relies on a continuous distribution of visually unique features on the surface. The system is thus not adapted for use on visually uniform surfaces. The system also requires a downward facing video camera and image processing electronics. These components render the system relatively expensive.

One method for determining position in a wheeled vehicle that steers by dead reckoning provides a marked floor. A linear detector mounted transversely in the vehicle observes the markings and obtains various measurements. Additional hardware aboard the vehicle determines the position of the vehicle based upon the measurements. The method disadvantageously requires mark detecting sensors aboard the vehicle and aesthetically unappealing marks on the floor. Further, the accuracy in placement of the marks limits the potential accuracy of the method.

Another inertial navigation system includes automatic redundancy and dynamic compensation of gyroscope drift error. This system requires inertial measurement hardware, which is relatively expensive. Even with the relatively expensive hardware, the system is still prone to accumulated error.

Many vehicles include wheels having treads to minimize slippage. Disadvantageously, the tread contours that maximize traction also cause vibration and tread wear. Furthermore, tread patterns that are optimized for deduced reckoning accuracy on carpets are generally not ideal for hard floors. Tread patterns that are useful on both floor types typically involve substantial compromises in tread performance.

Another robotic mobility arrangement includes only two driven wheels that contact the floor when the robotic vehicle is at rest. This system provides inadequate balance stability in comparison with vehicles having three or more wheels in contact with the floor. To prevent capsizing, either the vehicle center of gravity must be located below the axle line, or the vehicle must include a continuously active closed loop servo system, including at least one tilt sensor or accelerometer in addition to the customary rotary encoder feedback.

Another robotic vehicle includes two driven wheels and two passive wheels arranged in an independently articulating configuration. Unfortunately, the large allowable vertical motion of each wheel increases the tendency of the vehicle to tilt. Further, the self-aligning motion of the passive wheels is unpredictable when the vehicle changes direction. The passive wheels thus introduce varying transverse forces that result in disadvantageous slippage of the driven wheels.

The Trilobite™ is a robotic vacuum cleaning product manufactured by Electrolux®. The Trilobite™ includes two independently suspended drive wheels and five fixed-alignment rollers. The five fixed-alignment rollers have somewhat abrupt corners. These corners may create disadvantageous friction forces when the robot turns on carpeting. The abrupt corners plow through the carpeting rather than sliding smoothly above it. This plowing action causes drive wheel slippage that contributes to deduced reckoning error accumulation.

As the examples described above illustrate, past attempts at reducing error accumulation in deduced reckoning have either been relatively expensive or have been applicable in only limited situations. Therefore, a system for reducing error accumulation in deduced reckoning that is relatively inexpensive and useful in a wide range of applications would be of great benefit in the field of mobile robotics.

### SUMMARY OF THE INVENTION

The preferred embodiments of the present mechanical arrangement and components for deduced reckoning have several features, no single one of which is solely responsible for their desirable attributes. Without limiting the scope of this arrangement or these components as expressed by the claims that follow, certain features will now be discussed briefly. After considering this discussion, and particularly after reading the section entitled “Detailed Description of the Preferred Embodiments,” one will understand how the features of the preferred embodiments provide advantages, which include vehicle stability and reduced wheel slippage without requiring either the vehicle center of gravity to be below the axle line of the driven wheels, or stability enhancing closed loop control. Further advantages include excellent performance on a wide variety of support surfaces, and easy adaptability to a wide variety of applications.

One embodiment of the present mechanical arrangement and components for reducing error in deduced reckoning comprises a mobile robotic vehicle having a maximum acceleration equal to a₁, a maximum deceleration equal to a₂, and having a total vehicle weight. The vehicle further comprises at least a first driven wheel and a second driven wheel. The driven wheels are rotatable about a drive axis. A vertical axis through the center of gravity of the vehicle intersects or nearly intersects the drive axis at or near a midpoint between the driven wheels. The center of gravity of the vehicle is located at a height h above a support surface upon which the vehicle rests. The vehicle further comprises at least a first rolling element located to a first side of the drive axis. The first rolling element is rotatable about a first rolling axis that is parallel to the drive axis and separated from the drive axis by a first horizontal distance r₁. The vehicle further comprises at least a second rolling element located to a second side of the drive axis. The second rolling element is rotatable about a second rolling axis that is parallel to the drive axis and separated from the drive axis by a second horizontal distance r₂. A percentage of the total vehicle weight carried by the drive wheels is less than or equal to the following quantity

$$min ( 1 - \frac{{a}_{1} h}{{gr}_{1}} , 1 - \frac{{a}_{2} h}{{gr}_{2}} ) ;$$

where g is equal to gravitational acceleration in a vicinity of the vehicle.

Another embodiment of the present mechanical arrangement and components for reducing error in deduced reckoning comprises a mobile robotic vehicle having a maximum acceleration equal to a₁, and having a total vehicle weight. The vehicle further comprises at least a first driven wheel and a second driven wheel. The driven wheels are rotatable about a drive axis. A vertical axis through the center of gravity of the vehicle intersects or nearly intersects the drive axis at or near a midpoint between the driven wheels. The center of gravity of the vehicle is located at a height h above a support surface upon which the vehicle rests. The vehicle further comprises at least a first rolling element located to a first side of the drive axis. The first rolling element is rotatable about a first rolling axis that is parallel to the drive axis and separated from the drive axis by a first horizontal distance r₁. A percentage of the total vehicle weight carried by the drive wheels is less than or equal to the following quantity

$$1 - \frac{{a}_{1} h}{{gr}_{1}} ;$$

where g is equal to gravitational acceleration in a vicinity of the vehicle.

Another embodiment of the present mechanical arrangement and components for reducing error in deduced reckoning comprises a mobile robotic vehicle having a maximum deceleration equal to a₂, and having a total vehicle weight. The vehicle further comprises at least a first driven wheel and a second driven wheel. The driven wheels are rotatable about a drive axis. A vertical axis through the center of gravity of the vehicle intersects or nearly intersects the drive axis at or near a midpoint between the driven wheels. The center of gravity of the vehicle is located at a height h above a support surface upon which the vehicle rests. The vehicle further comprises at least a first rolling element located to a first side of the drive axis. The first rolling element is rotatable about a first rolling axis that is parallel to the drive axis and separated from the drive axis by a first horizontal distance r₂. A percentage of the total vehicle weight carried by the drive wheels is less than or equal to the following quantity

$$1 - \frac{{a}_{2} h}{{gr}_{2}} ;$$

where g is equal to gravitational acceleration in a vicinity of the vehicle.

Another embodiment of the present mechanical arrangement and components for reducing error in deduced reckoning comprises a mobile robotic vehicle having a maximum acceleration equal to a₁, a maximum deceleration equal to a₂, and a total vehicle weight. The vehicle further comprises at least a first driven wheel. The driven wheel is rotatable about a drive axis. A vertical axis through the center of gravity of the vehicle intersects or nearly intersects the driven wheel. The center of gravity of the vehicle is located at a height h above a support surface upon which the vehicle rests. The vehicle further comprises at least a first rolling element located to a first side of the drive axis. The first rolling element is rotatable about a first rolling axis that is parallel to the drive axis and separated from the drive axis by a first horizontal distance r₁. The vehicle further comprises at least a second rolling element located to a second side of the drive axis. The second rolling element is rotatable about a second rolling axis that is parallel to the drive axis and separated from the drive axis by a second horizontal distance r₂. A percentage of the total vehicle weight carried by the drive wheel is less than or equal to the following quantity

$$min ( 1 - \frac{{a}_{1} h}{{gr}_{1}} , 1 - \frac{{a}_{2} h}{{gr}_{2}} ) ;$$

where g is equal to gravitational acceleration in a vicinity of the vehicle.

Another embodiment of the present mechanical arrangement and components for reducing error in deduced reckoning comprises a rolling element for supporting a mobile robotic vehicle. The rolling element comprises a rolling surface having a generally prolate spheroid shape.

Another embodiment of the present mechanical arrangement and components for reducing error in deduced reckoning comprises a rolling element for supporting a mobile robotic vehicle. The rolling element comprises a central portion that is substantially cylindrical, and end portions that each taper monotonically from a larger diameter to a smaller diameter in a direction away from the central portion.

Another embodiment of the present mechanical arrangement and components for reducing error in deduced reckoning comprises a mobile robotic vehicle having a first driven wheel and a second driven wheel. The driven wheels are rotatable about a drive axis. The vehicle further comprises at least a first rolling element located aft of the drive axis and a second rolling element located fore of the drive axis. The rolling elements are each fixed with respect to the vehicle against rotation about a vertical axis and translation along the vertical axis. Each rolling element comprises a rolling surface having a prolate spheroid shape.

Another embodiment of the present mechanical arrangement and components for reducing error in deduced reckoning comprises a mobile robotic vehicle having a maximum acceleration equal to a₁, a maximum deceleration equal to a₂, and a total vehicle weight. The vehicle further comprises a first driven wheel and a second driven wheel. The driven wheels are rotatable. The center of gravity of the vehicle is located at a height h above a support surface upon which the vehicle rests. The vehicle further comprises a first rolling element located to a first side of the driven wheels. The first rolling element is rotatable and is separated from the driven wheels by a first horizontal distance r₁. The vehicle further comprises a second rolling element located to a second side of the driven wheels. The second rolling element is rotatable and is separated from the driven wheels by a second horizontal distance r₂. A percentage of the total vehicle weight carried by the drive wheels depends at least in part upon the following quantities: a₁, a₂, h, r₁, and r₂.

Another embodiment of the present mechanical arrangement and components for reducing error in deduced reckoning comprises a mobile robotic vehicle having a vehicle body, at least one motor providing locomotion to the vehicle, at least one power source and at least one control system. The vehicle has a maximum acceleration equal to a₁, a maximum deceleration equal to a₂, and a total vehicle weight. The vehicle further comprises at least a first driven wheel and a second driven wheel. The driven wheels are rotatable about a drive axis. A vertical axis through the center of gravity of the vehicle intersects or nearly intersects the drive axis at or near a midpoint between the driven wheels. The center of gravity of the vehicle is located at a height h above a support surface upon which the vehicle rests. The vehicle further comprises at least a first rolling element located to a first side of the drive axis. The first rolling element is rotatable about a first rolling axis that is parallel to the drive axis and separated from the drive axis by a first horizontal distance r₁. The vehicle further comprises at least a second rolling element located to a second side of the drive axis. The second rolling element is rotatable about a second rolling axis that is parallel to the drive axis and separated from the drive axis by a second horizontal distance r₂. A percentage of the total vehicle weight carried by the drive wheels is less than or equal to the following quantity

$$min ( 1 - \frac{{a}_{1} h}{{gr}_{1}} , 1 - \frac{{a}_{2} h}{{gr}_{2}} ) ;$$

where g is equal to gravitational acceleration in a vicinity of the vehicle.

### BRIEF DESCRIPTION OF THE DRAWINGS

Example embodiments of the present mechanical arrangement and components for reducing error in deduced reckoning, illustrating their features, will now be discussed in detail. These embodiments depict the novel and non-obvious mechanical arrangement and components for deduced reckoning shown in the accompanying drawings, which are for illustrative purposes only. These drawings include the following figures, in which like numerals indicate like parts:

FIG. 1 is a schematic side perspective view of a mobile robotic vehicle including an example embodiment of the present mechanical arrangement and components for reducing error in deduced reckoning;

FIG. 2 is a schematic side elevational view of the driven wheels and rolling elements of the mechanical arrangement and components of FIG. 1, illustrating the parameters that determine a preferred weight distribution for a mobile robotic vehicle;

FIG. 3 is a front perspective view of an example embodiment of a rolling element of the mechanical arrangement and components of FIG. 1;

FIG. 4 is a front elevational view of the rolling element of FIG. 3;

FIG. 5 is a front elevational view of another example embodiment of a rolling element of the mechanical arrangement and components of FIG. 1;

FIG. 6 is a front elevational view of another example embodiment of a rolling element of the mechanical arrangement and components of FIG. 1; and

FIG. 7 is a front elevational view of another example embodiment of a rolling element of the mechanical arrangement and components of FIG. 1.

### DETAILED DESCRIPTION OF PREFERRED EMBODIMENTS

The present mechanical arrangement and components for reducing error in deduced reckoning reduce or minimize deduced reckoning error accumulation by reducing or minimizing slippage between the driven wheels and the support surface. The system provides advantageous vehicle weight distribution for a given mobile robotic vehicle. The system also advantageously provides tilt stability without closed loop tilt control. The system performs well on a variety of support surfaces, such as carpeted floors and hard floors. The system is easily adaptable to a wide variety of applications, including commercial mobile robotic products, such as robotic floor cleaners, lawn mowers, inventory assessment devices, and medical transportation devices.

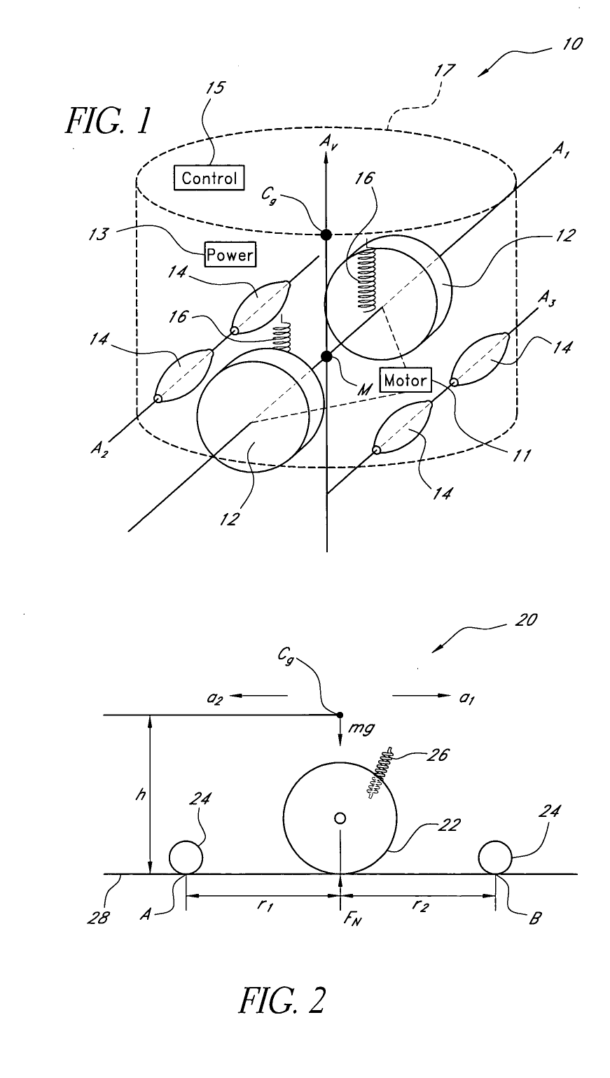

FIG. 1 illustrates an example of a mobile robotic vehicle 10 that incorporates the present system. The vehicle 10 includes a vehicle body 17, and two driven wheels 12 disposed symmetrically on either side of the vehicle 10. The wheels 12 are preferably each rotatable about a common first horizontal axis A₁. The first horizontal, axis A₁ is fixed with respect to the vehicle 10 against rotation about a vertical axis. A vertical axis A_{V} that passes through the center of gravity C_{g} of the vehicle 10 preferably intersects, or nearly intersects, the first horizontal axis A₁ at or near a midpoint M between the wheels 12.

Those of skill in the art will appreciate that fewer or additional driven wheels 12 could be provided, and that all driven wheels 12 need not be rotatable about a common axis. For example, in a vehicle that includes only one driven wheel 12, the driven wheel 12 could be located directly beneath the vehicle center of gravity C_{g}.

The wheels 12 preferably maintain contact with the support surface, and the wheels 12 together carry a predetermined portion of the vehicle weight, as described below, in order to reduce or minimize wheel slippage. To further reduce or minimize wheel slippage, the portions of the wheels 12 that contact the support surface are preferably constructed of a durable, long-wearing material having a high coefficient of friction on the support surface. A preferred material is urethane.

At least one motor 11 drives the driven wheels 12 to provide locomotion for the vehicle 10. A power source 13 provides power to run the motor 11. The power source 13 may be, for example, a battery, a solar array, or AC power obtained from an AC outlet. Those of skill in the art will appreciate that the vehicle 10 may include more than one motor 11. For example, the vehicle 10 may include a separate motor 11 for each driven wheel 12. A control system 15, which is coupled to the power source 13 and the motor 11, controls the movement of the vehicle 10. The vehicle 10 may include various sensors, such as a bump sensor that halts vehicle motion when the vehicle 10 strikes an object.

With continued reference to FIG. 1, the vehicle 10 further includes non-driven rolling elements 14. The rolling elements 14 together carry the remaining portion of the vehicle weight that is not carried by the driven wheels 12. The rolling elements 14 are positioned fore and aft of the driven wheels 12, and each is rotatable about an associated horizontal axis A₂, A₃. Some of the rolling elements 14 may be rotatable about a common axis. The rolling elements 14 are fixed with respect to the vehicle 10 against translation along and rotation about a vertical axis. This fixing contributes to decreased vehicle tilting, as described below.

FIG. 1 illustrates one example of an arrangement for the rolling elements 14, wherein two rolling elements 14 are positioned side-by-side fore of the driven wheels 12, and two rolling elements 14 are positioned side-by-side aft of the driven wheels 12. Those of skill in the art will appreciate that the rolling elements 14 could be positioned differently, and that more or fewer rolling elements 14 could be provided. Preferably, however, at least three rolling elements 14 are provided, and the rolling elements 14 are positioned to prevent tilting fore and aft when the vehicle 10 accelerates. The rolling elements 14 are also preferably positioned to prevent tilting from side to side. Once the positions of the rolling elements 14 are determined, the preferred weight distribution over the driven wheels 12 and the rolling elements 14 is determined according to a mathematical relationship provided below.

Reducing or minimizing wheel slippage requires balancing competing vehicle parameters. First, greater normal force upon the driven wheels 12 generates greater friction between the driven wheels 12 and the support surface. Greater friction lessens the likelihood of wheel slippage. Therefore, it may seem to be most advantageous to have the driven wheels 12 support as much of the vehicle weight as possible. However, in the vehicle arrangement illustrated in FIG. 1, the axis of rotation A₁ of the driven wheels 12 is located near the front-to-back vehicle center. Therefore, heavily loading the driven wheels 12 would concentrate a relatively large amount of weight at the front-to-back vehicle center. Such loading would increase the tendency of the vehicle 10 to tilt during acceleration in either direction. Tilting would reduce the load on the driven wheels 12 and at least some of the rolling elements 14, which would contribute to slippage. Therefore, to reduce or minimize tilt, some fraction of the total vehicle weight is preferably distributed toward the front and back edges of the vehicle 10, away from the driven wheels 12.

FIG. 2 illustrates a schematic representation of a simplified robotic vehicle 20. For simplicity, the vehicle 20 includes only one driven wheel 22 and two rolling elements 24. The driven wheel 22 is centrally-located, with the rolling elements 24 positioned fore and aft. A spring 26 suspends the driven wheel 22 with respect to the vehicle chassis (not shown). As illustrated in FIG. 2, the vehicle parameters that determine the preferred vehicle weight distribution for reduced or minimal wheel slippage are labeled as follows:
C_{g}=vehicle center of gravity;
h=height of the vehicle center of gravity;
a₁=maximum vehicle acceleration (a constant for any given vehicle);
a₂=maximum vehicle deceleration (a constant for any given vehicle);
F_{N}=normal force upon driven wheel 22; and
r₁=horizontal distance between drive wheel axis of rotation and axis of rotation associated with rolling element 24 aft of driven wheel 22;
r₂=horizontal distance between drive wheel axis of rotation and axis of rotation associated with rolling element 24 fore of driven wheel 22.

The parameter F_{N} is determined according to the following equation:
F_{N}=mgx
where
m=total vehicle mass;
g=gravitational acceleration in the vicinity of the robot (a constant approximately equal to 9.81 m/s²); and
x=fraction of vehicle weight supported by the drive wheel 22.

To determine the value of x, we begin by determining the forces that act on the vehicle 20:
mg=vehicle weight;
ma₁=reaction force generated by the maximum vehicle acceleration;
ma₂=reaction force generated by the maximum vehicle deceleration;
mgx=normal force at the drive wheel 22; and
mg(1−x)=combined normal force on all rolling elements 24.

For an acceleration (left-to-right in FIG. 2), the reaction force mal generated by the maximum vehicle acceleration a₁ tends to reduce the load on the rolling element 24 at point B. Similarly, for a deceleration (right-to-left in FIG. 2), the reaction force ma₂ generated by the maximum vehicle deceleration a₂ tends to reduce the load on the rolling element 24 at point A. Preferably, the rolling elements 24 maintain contact with a support surface 28. Therefore, to determine the maximum value of x that will maintain contact between the rolling element 24 at point B and the support surface 28 under maximum vehicle acceleration, we set the normal force at point B equal to zero and sum moments about the other rolling element 24 at point A. Similarly, to determine the maximum value of x that will maintain contact between the rolling element 24 at point A and the support surface 28 under maximum vehicle deceleration, we set the normal force at point A equal to zero and sum moments about the other rolling element 24 at point B. The normal force at point A generates no moment about point A and the normal force at point B generates no moment about point B. Therefore, the summations are as follows:
mgxr₁−mgr₁+ma₁h=0 Eq. 1; and
−mgxr₂+mgr₂−ma₂h=0 Eq. 2

Dividing both sides of each equation by m simplifies the equations as follows:
gxr₁−gr₁+a₁h=0 Eq. 1; and
−gxr₂+gr₂−a₂h=0 Eq. 2

Thus, the value of x does not depend upon the vehicle's mass. Solving the above equations for x:

$$Eq . 1 \text{:} {gxr}_{1} = {gr}_{1} - {a}_{1} h$$

$$Eq . 1 \text{:} x = 1 - \frac{{a}_{1} h}{{gr}_{1}} ; and$$

$$Eq . 2 \text{:} {gxr}_{2} = {gr}_{2} - {a}_{2} h$$

$$Eq . 2 \text{:} x = 1 - \frac{{a}_{2} h}{{gr}_{2}}$$

These two mathematical relationships specify the maximum portion of total vehicle weight that is preferably carried by the driven wheels in order to ensure that the vehicle does not tilt during maximum vehicle accelerations or decelerations. The value of x depends upon the maximum vehicle acceleration a₁, the maximum vehicle deceleration a₂, the height h of the vehicle center of gravity, the distance r₁ between the axis of rotation of the driven wheel and the axis of rotation of the rolling element aft of the driven wheels, and the distance r₂ between the axis of rotation of the driven wheel and the axis of rotation of the rolling element fore of the driven wheel. These five values are all constants for a given vehicle.

For robotic vehicles in which a₁ does not equal a₂, and/or r₁ does not equal r₂, the value of x in Eq. 1 will most likely not equal the value of x in Eq. 2. In such a situation, in order that the vehicle rolling elements maintain contact with the ground regardless of whether the vehicle experiences an acceleration or a deceleration, x is preferably minimized. Therefore,

$$x = min ( 1 - \frac{{a}_{1} h}{{gr}_{1}} , 1 - \frac{{a}_{2} h}{{gr}_{2}} )$$

If the fraction of vehicle weight carried by the driven wheels is somewhat greater than the value of x that is calculated according to the equation above, the vehicle may still perform adequately with little or no tilting. However, to provide a margin of safety against vehicle tilting, preferably the fraction of vehicle weight carried by the driven wheels is set somewhere below the value of x. For example, the fraction of vehicle weight carried by the driven wheels could be set somewhere between 80% and 90% of x. Of course, as the fraction of vehicle weight carried by the driven wheels decreases further, the tendency for the vehicle to tilt also decreases. Preferably, however, the fraction of vehicle weight carried by the driven wheels is great enough so that the driven wheels do not tend to slip relative to the support surface under the influence of the motor.

With reference to FIG. 1, to ensure that the driven wheels 12 do not lose contact with the support surface even when the support surface is uneven, preferably springs 16 mount the driven wheels 12 to the vehicle chassis (not shown). When the vehicle 10 is at rest, the springs 16 experience a static load equal to mgx (the vehicle weight multiplied by the percentage of the vehicle weight carried by the driven wheels 12). Preferably, the springs 16 have a relatively soft spring rate. The following equation provides the starting point for determining the appropriate spring rate:
mgx=kd
where
k=spring rate; and
d=spring displacement.

The left-hand side of this equation is known. The mass m of the vehicle 10 is a constant, as is the value of gravitational acceleration g. For a given vehicle, the value of x is determined according to the relationship

$$x = min ( 1 - \frac{{a}_{1} h}{{gr}_{1}} , 1 - \frac{{a}_{2} h}{{gr}_{2}} ) ,$$

which relationship was derived above. Thus, the product of k and d has a known value.

Once the value of the product of k and d is calculated, determining the value of k becomes a matter of practicality. A wide variety of mass-produced springs are available for use in a given robotic vehicle. Each has its own value of k, and each has its own maximum displacement dₘₐₓ. If the maximum displacement dₘₐₓ is exceeded, the spring could be damaged. Thus, the selected springs preferably provide a minimum k for which the maximum displacement dₘₐₓ will not be exceeded during normal operation of the vehicle.

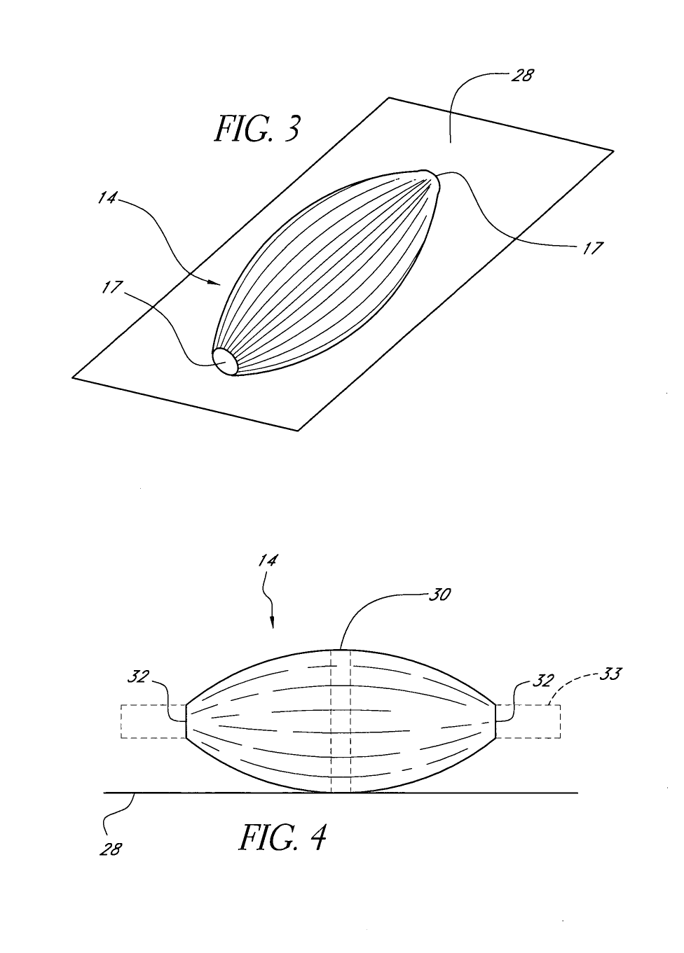

The present mechanical arrangement further reduces or minimizes wheel slippage by providing uniquely shaped rolling elements 14, 34, 44 (FIGS. 3-7). As described above, in an example embodiment the rolling elements 14 are fixed with respect to the vehicle 10 against rotation about a vertical axis A_{V} (FIG. 1). Thus, when the vehicle 10 turns, the rolling elements 14 tend to slide sideways across the support surface 28. The present rolling elements 14, 34, 44 are preferably shaped so as to reduce or minimize side forces from sliding friction while the vehicle 10 is turning. For example, each rolling element 14 may be shaped substantially as a prolate spheroid (the surface generated by revolving an ellipse about its major axis), as illustrated in FIGS. 3-5.

The illustrated rolling elements 14 include truncated end portions 32. However, those of skill in the art will appreciate that the rolling elements 14 need not include truncated end portions 32. To further reduce or minimize side forces, the rolling elements 14 are preferably constructed of a durable, long-wearing material having a low coefficient of friction on the support surface. A preferred material is acetal plastic.

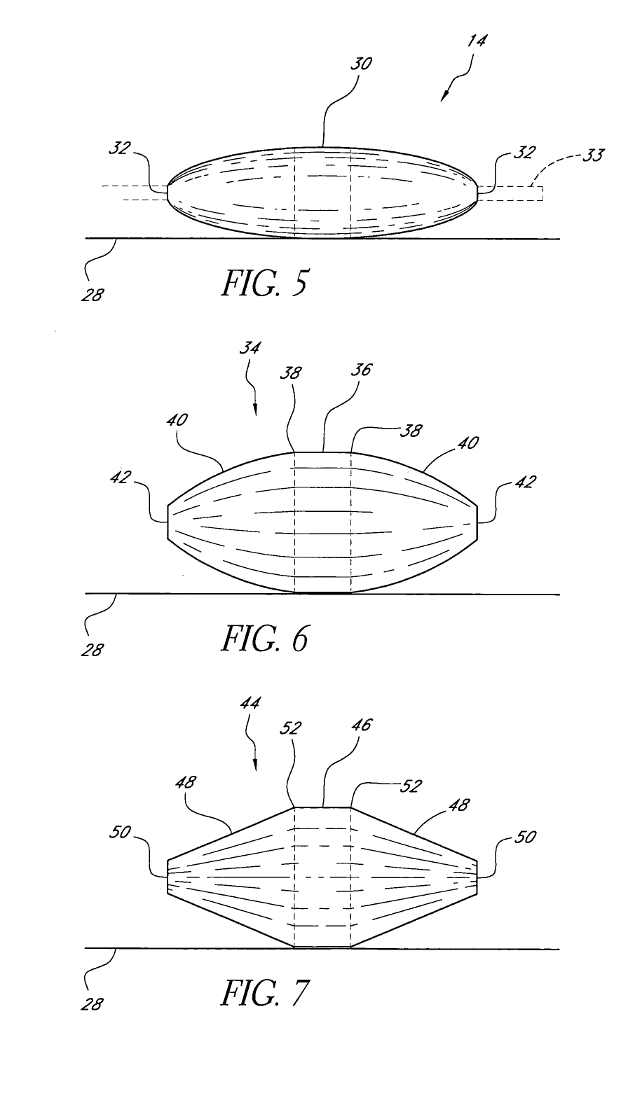

As illustrated in FIGS. 4 and 5, the rolling surfaces of the rolling elements 14 define smooth curves. Thus, a narrow central band 30 of each rolling element 14 contacts the support surface 28 over which the vehicle 10 moves. The width of the central band 30 depends upon the radius of curvature of the rolling element 14 near its center. Comparing FIGS. 4 and 5, the rolling element 14 of FIG. 4 has a larger radius of curvature near its center than the rolling element 14 of FIG. 5 does. Accordingly, the central band 30 in FIG. 5 is wider than that in FIG. 4.

The portions to either side of the center of each rolling element 14 slope upwardly away from the support surface 28. Thus, when the vehicle 10 turns, the rolling elements 14 easily slide over the support surface 28. The rolling elements 14 do not tend to catch on or dig into the support surface 28, which would generate horizontally directed forces on the vehicle 10. These horizontally directed forces would tend to tilt the vehicle 10. The tilting would tend to reduce the load on some of the wheels 12 and cause wheel slippage. The uniquely shaped rolling elements 14 thus reduce or minimize horizontally directed forces, which are one potential cause of wheel slippage.

The rolling elements 14 also preferably taper smoothly to a minimum radius at the truncated end portions 32. For each rolling element 14, the ratio of the minimum radius to the maximum radius is preferably small. For example, a preferred ratio is less than ¾, a more preferred ratio is less than ½, and a still more preferred ratio is less than ¼. The minimum radius for each rolling element 14 is also preferably approximately equal to the radius of the axle 33 upon which the rolling element 14 is mounted. This configuration eliminates abrupt edges that might catch on or dig into the support surface 28, thereby further reducing or minimizing horizontally directed forces.

FIG. 6 illustrates another example embodiment of a rolling element 34. In the rolling element 34 of FIG. 6, the rolling surfaces do not define smooth curves from one end 42 of the rolling element 34 to the other end 42. Instead, a central portion 36 of the rolling element 34 is substantially cylindrical. At edges 38 of the central portion 36 the rolling surface transitions into smoothly tapering curved portions 40. The curved portions 40 extend outwardly toward truncated end portions 42. This embodiment similarly avoids the creation of horizontally directed forces on the vehicle 10.

FIG. 7 illustrates another example embodiment of a rolling element 44. The rolling element 44 of FIG. 7 includes a substantially cylindrical central portion 46 with substantially cone-shaped portions 48 on either side thereof. The cone shaped portions 48 each taper from a larger diameter near the central portion 46 to a smaller diameter distant from the central portion 46. The cones terminate in truncated end portions 50. Preferably, the central portion 46 transitions smoothly into the cone-shaped portions 48 so that borders 52 between these portions do not form edges that might catch on a support surface and generate horizontally directed forces on the vehicle 10.

### SCOPE OF THE INVENTION

The above presents a description of the best mode contemplated for carrying out the present mechanical arrangement and components for reducing error in deduced reckoning, and of the manner and process of making and using it, in such full, clear, concise, and exact terms as to enable any person skilled in the art to which it pertains to make and use this system. This system is, however, susceptible to modifications and alternate constructions from that discussed above that are fully equivalent. Consequently, this system is not limited to the particular embodiments disclosed. On the contrary, this system covers all modifications and alternate constructions coming within the spirit and scope of the system as generally expressed by the following claims, which particularly point out and distinctly claim the subject matter of the system.

1. A mechanical arrangement for deduced reckoning that reduces or minimizes deduced reckoning error accumulation in a mobile robotic vehicle, the arrangement comprising:
a mobile robotic vehicle having a maximum acceleration equal to a₁, having a maximum deceleration equal to a₂, and having a total vehicle weight;
at least a first driven wheel and a second driven wheel, the driven wheels being rotatable about a drive axis, a vertical axis through the center of gravity of the vehicle intersecting or nearly intersecting the drive axis at or near a midpoint between the driven wheels, the center of gravity of the vehicle being located at a height h above a support surface upon which the vehicle rests;
at least a first rolling element located to a first side of the drive axis, the first rolling element being rotatable about a first rolling axis that is parallel to the drive axis and separated from the drive axis by a first horizontal distance r₁; and
at least a second rolling element located to a second side of the drive axis, the second rolling element being rotatable about a second rolling axis that is parallel to the drive axis and separated from the drive axis by a second horizontal distance r₂, wherein
a percentage of the total vehicle weight carried by the drive wheels is less than or equal to the following quantity
$$min ( 1 - \frac{{a}_{1} h}{{gr}_{1}} , 1 - \frac{{a}_{2} h}{{gr}_{2}} ) ;$$
where
g is equal to gravitational acceleration in a vicinity of the vehicle.

2. The mechanical arrangement of claim 1, wherein the driven wheels are translatable with respect to the vehicle.

3. The mechanical arrangement of claim 1, wherein the rolling elements are fixed against translation with respect to the vehicle.

4. The mechanical arrangement of claim 1, wherein the rolling elements are fixed with respect to the vehicle against rotation about a vertical axis that is parallel to the vertical axis through the vehicle center of gravity.

5. The mechanical arrangement of claim 1, wherein the rolling elements are shaped as generally as prolate spheroids.

6. The mechanical arrangement of claim 5, wherein only a narrow central band of each rolling element contacts the support surface as the vehicle moves.

7. The mechanical arrangement of claim 1, wherein the rolling elements are constructed of a durable, long-wearing material having a low coefficient of friction on the support surface.

8. The mechanical arrangement of claim 7, wherein the rolling element is constructed of acetal plastic.

9. The mechanical arrangement of claim 1, wherein the portions of the driven wheels that contact the support surface are constructed of a durable, long-wearing material having a high coefficient of friction on the support surface.

10. The mechanical arrangement of claim 9, wherein the portions of the driven wheels that contact the support surface are constructed of urethane.

11. A mechanical arrangement for deduced reckoning that reduces or minimizes deduced reckoning error accumulation in a mobile robotic vehicle, the arrangement comprising:
a mobile robotic vehicle having a maximum acceleration equal to a₁, and having a total vehicle weight;
at least a first driven wheel and a second driven wheel, the driven wheels being rotatable about a drive axis, a vertical axis through the center of gravity of the vehicle intersecting or nearly intersecting the drive axis at or near a midpoint between the driven wheels, the center of gravity of the vehicle being located at a height h above a support surface upon which the vehicle rests; and
at least a first rolling element located to a first side of the drive axis, the first rolling element being rotatable about a first rolling axis that is parallel to the drive axis and separated from the drive axis by a first horizontal distance r₁; wherein
a percentage of the total vehicle weight carried by the drive wheels is less than or equal to the following quantity
$$1 - \frac{{a}_{1} h}{{gr}_{1}} ;$$
where
g is equal to gravitational acceleration in a vicinity of the vehicle.

12. The mechanical arrangement of claim 11, further comprising at least a second rolling element located to a second side of the drive axis, the second rolling element being rotatable about a second rolling axis that is parallel to the drive axis.

13. A mechanical arrangement for deduced reckoning that reduces or minimizes deduced reckoning error accumulation in a mobile robotic vehicle, the arrangement comprising:
a mobile robotic vehicle having a maximum deceleration equal to a₂, and having a total vehicle weight;
at least a first driven wheel and a second driven wheel, the driven wheels being rotatable about a drive axis, a vertical axis through the center of gravity of the vehicle intersecting or nearly intersecting the drive axis at or near a midpoint between the driven wheels, the center of gravity of the vehicle being located at a height h above a support surface upon which the vehicle rests; and
at least a first rolling element located to a first side of the drive axis, the first rolling element being rotatable about a first rolling axis that is parallel to the drive axis and separated from the drive axis by a first horizontal distance r₂; wherein
a percentage of the total vehicle weight carried by the drive wheels is less than or equal to the following quantity
$$1 - \frac{{a}_{2} h}{g {r}_{2}} ;$$
where
g is equal to gravitational acceleration in a vicinity of the vehicle.

14. The mechanical arrangement of claim 13, further comprising at least a second rolling element located to a second side of the drive axis, the second rolling element being rotatable about a second rolling axis that is parallel to the drive axis.

15. A mechanical arrangement for deduced reckoning that reduces or minimizes deduced reckoning error accumulation in a mobile robotic vehicle, the arrangement comprising:
a mobile robotic vehicle having a maximum acceleration equal to a₁, having a maximum deceleration equal to a₂, and having a total vehicle weight;
at least a first driven wheel, the driven wheel being rotatable about a drive axis, a vertical axis through the center of gravity of the vehicle intersecting or nearly intersecting the driven wheel, the center of gravity of the vehicle being located at a height h above a support surface upon which the vehicle rests;
at least a first rolling element located to a first side of the drive axis, the first rolling element being rotatable about a first rolling axis that is parallel to the drive axis and separated from the drive axis by a first horizontal distance r₁; and
at least a second rolling element located to a second side of the drive axis, the second rolling element being rotatable about a second rolling axis that is parallel to the drive axis and separated from the drive axis by a second horizontal distance r₂; wherein
a percentage of the total vehicle weight carried by the driven wheel is less than or equal to the following quantity
$$min ( 1 - \frac{{a}_{1} h}{g {r}_{1}} , 1 - \frac{{a}_{2} h}{g {r}_{2}} ) ;$$
where
g is equal to gravitational acceleration in a vicinity of the vehicle.

16. A rolling element for supporting a mobile robotic vehicle, the rolling element comprising a rolling surface having a generally prolate spheroid shape.

17. The rolling element of claim 16, wherein the rolling element has a minimum radius and a maximum radius, and a ratio of the minimum radius to the maximum radius is less than ¾.

18. The rolling element of claim 17, wherein the ratio of the minimum radius to the maximum radius is less than ½.

19. The rolling element of claim 17, wherein the ratio of the minimum radius to the maximum radius is less than ¼.

20. The rolling element of claim 16, wherein when the rolling element is viewed in front elevational aspect, the rolling element resembles an ellipse having flattened ends.

21. The rolling element of claim 16, wherein as the rolling element rolls in a straight line across a support surface, only a narrow central band of the rolling element contacts the support surface.

22. The rolling element of claim 16, wherein the rolling element is constructed of a durable, long-wearing material having a low coefficient of friction on a support surface.

23. The rolling element of claim 22, wherein the rolling element is constructed of acetal plastic.

24. A rolling element for supporting a mobile robotic vehicle, the rolling element comprising a central portion that is substantially cylindrical, and end portions that each taper monotonically from a larger diameter to a smaller diameter in a direction away from the central portion.

25. The rolling element of claim 24, wherein when the rolling element is viewed in front elevational aspect, surfaces of the end portions define smooth curves.

26. The rolling element of claim 24, wherein when the rolling element is viewed in front elevational aspect, surfaces of the end portions define straight lines.

27. A mechanical arrangement for deduced reckoning that reduces or minimizes deduced reckoning error accumulation in a mobile robotic vehicle, the arrangement comprising:
a mobile robotic vehicle having a first driven wheel and a second driven wheel, the driven wheels being rotatable about a drive axis;
at least a first rolling element located aft of the drive axis and a second rolling element located fore of the drive axis; wherein
the rolling elements are each fixed with respect to the vehicle against rotation about a vertical axis and translation along the vertical axis; and
each rolling element comprises a rolling surface having a prolate spheroid shape.

28. The mechanical arrangement of claim 27, wherein the driven wheels are translatable with respect to the vehicle along the vertical axis.

29. The mechanical arrangement of claim 27, wherein a vertical axis through the center of gravity of the vehicle intersects or nearly intersects the drive axis at or near a midpoint between the driven wheels.

30. A mechanical arrangement for deduced reckoning that reduces or minimizes deduced reckoning error accumulation in a mobile robotic vehicle, the arrangement comprising:
a mobile robotic vehicle having a maximum acceleration equal to a₁, having a maximum deceleration equal to a₂, and having a total vehicle weight;
a first driven wheel and a second driven wheel, the driven wheels being rotatable, the center of gravity of the vehicle being located at a height h above a support surface upon which the vehicle rests;
a first rolling element located to a first side of the driven wheels, the first rolling element being rotatable and being separated from the driven wheels by a first horizontal distance r₁; and
a second rolling element located to a second side of the driven wheels, the second rolling element being rotatable and being separated from the driven wheels by a second horizontal distance r₂; wherein
a percentage of the total vehicle weight carried by the drive wheels depends at least in part upon the following quantities: a₁, a₂, h, r₁, and r₂.

31. A mobile robotic vehicle, comprising:
a vehicle body, at least one motor providing locomotion to the vehicle, at least one power source and at least one control system, the vehicle having a maximum acceleration equal to a₁, having a maximum deceleration equal to a₂, and having a total vehicle weight;
at least a first driven wheel and a second driven wheel, the driven wheels being rotatable about a drive axis, a vertical axis through the center of gravity of the vehicle intersecting or nearly intersecting the drive axis at or near a midpoint between the driven wheels, the center of gravity of the vehicle being located at a height h above a support surface upon which the vehicle rests;
at least a first rolling element located to a first side of the drive axis, the first rolling element being rotatable about a first rolling axis that is parallel to the drive axis and separated from the drive axis by a first horizontal distance r₁; and
at least a second rolling element located to a second side of the drive axis, the second rolling element being rotatable about a second rolling axis that is parallel to the drive axis and separated from the drive axis by a second horizontal distance r₂; wherein
a percentage of the total vehicle weight carried by the drive wheels is less than or equal to the following quantity
$$min ( 1 - \frac{{a}_{1} h}{g {r}_{1}} , 1 - \frac{{a}_{2} h}{g {r}_{2}} ) ;$$
where
g is equal to gravitational acceleration in a vicinity of the vehicle.
